(19) United States
(12) Patent Application Publication
(10) Pub. No.: US 2008/0245774 A1
(43) Pub. Date: Oct. 9, 2008

(54) Laser-rotate arc hybrid welding system and thereof method

(75) Inventors: Cheol-Hee Kim, Incheon (KR); Nam-Hyun Kang, Busan (KR); Jun-Ki Kim, Seoul (KR); Chang-Woo Lee, Anyang-si (KR)

Correspondence Address: CANTOR COLBURN, LLP, 20 Church Street, 22nd Floor, Hartford, CT, 06103, US

(73) Assignee: KOREA INSTITUTE OF INDUSTRIAL TECHNOLOGY, Cheonan-si (KR)

(21) Appl. No.: 12/157,209

(22) Filed: Jun. 9, 2008

(30) Foreign Application Priority Data
Dec. 26, 2005 (KR) 10-2005-0129626

(51) Int. Cl. B23K 26/00; B23K 9/00

(52) U.S. Cl. 219/74; 219/121.6; 219/121.64

(57) ABSTRACT

The present invention relates to a laser-rotating arc hybrid welding system and a welding method using the system. The laser-rotating arc hybrid welding system of the present invention includes an arc discharge unit (2) for generating arc discharge along an area to be welded. A laser generation unit (4) radiates laser light onto the area to be welded. A rotating device (24) rotates the arc discharge unit (2). In the welding method using the laser-rotating arc hybrid welding system, a plurality of parent metals is aligned with a welding location. A laser-rotating arc hybrid welding system is located with respect to an area to be welded, arc discharge is generated while an arc discharge unit is rotated at a predetermined turning radius, and laser light is subsequently radiated using a laser generation unit.

### TECHNICAL FIELD

The present invention relates, in general, to laser-rotating arc hybrid welding and, more particularly, to a laser-rotating arc hybrid welding system and welding method using the welding system, which can weld galvanized steel plates having a gap ranging from 1.5 to 2 mm therebetween without controlling the height of a torch when the galvanized steel plates are welded, and which can improve the fluidity of a weld pool through arc rotation, thus reducing the incidence of welding defects, such as undercutting.

### BACKGROUND ART

Generally, laser-Metal Inert Gas (MIG) welding has an allowable gap range of 1.5 mm or less for parts to be butt welded, and generally uses a welding wire having a thickness of 1.2 mm.

Typically, in the case where a gap exists between parts to be butt welded, laser-rotating arc hybrid welding can ensure weldability by controlling welding current and voltage in the case of a gap of less than 1 mm, but must additionally control the height of a torch in the case of a gap ranging from 1 to 1.5 mm, and must replace a 1.2 mm welding wire with a 1.4 mm welding wire in the case of a gap ranging from 1.5 to 2 mm because, if the 1.2 mm welding wire is used, the remaining portion of the gap is excessively large and thus welding is impossible.

Therefore, there is the inconvenience of performing an operation of replacing a welding wire, because a welding wire of 1.2 mm and a welding wire of 1.4 mm must be selectively applied depending on the gap in an area to be welded.

Further, there is a problem in that, since a separate shaft is required to control the height of a torch as described above, the system is complicated and not easily controlled.

### DISCLOSURE

### Technical Problem

Accordingly, the present invention has been made keeping in mind the above problems occurring in the prior art, and an object of the present invention is to provide a laser-rotating arc hybrid welding system and a welding method using the welding system, which perform hybrid welding, that is, perform laser welding and arc welding together, but rotate an arc discharge unit at a predetermined radius, so that a heat source can be sufficiently supplied to parts to be welded having a gap ranging from 1.5 to 2 mm therebetween, when using a 1.2 mm welding wire, thus sufficiently performing welding without controlling a torch, and which greatly improve the fluidity of a weld pool as the arc discharge unit rotates, thus reducing the incidence of welding defects, such as undercutting.

### Technical Solution

In order to accomplish the above object, the present invention provides a laser-rotating arc hybrid welding system, comprising an arc discharge unit for generating arc discharge along an area to be welded; a laser generation unit for radiating laser light onto the area to be welded; and a rotating device for rotating the arc discharge unit.

Further, the present invention provides a laser-rotating arc hybrid welding method, comprising a first step of aligning a plurality of parent metals with a welding location; and a second step of locating a laser-rotating arc hybrid welding system with respect to an area to be welded, generating arc discharge while rotating an arc discharge unit at a predetermined turning radius, and subsequently radiating laser light using a laser generation unit.

In addition, the present invention provides a laser-rotating arc hybrid welding method, comprising a first step of aligning a plurality of parent metals with a welding location; and a second step of locating a laser-rotating arc hybrid welding system with respect to an area to be welded, radiating laser light using a laser generation unit, and subsequently generating arc discharge using an arc discharge unit.

### Advantageous Effects

As described above, the laser-rotating arc hybrid welding system and welding method using the welding system according to the present invention are advantageous in that the range of welding can be extended by rotating an arc discharge unit at a predetermined turning radius, so that parts to be butt welded having a gap ranging from 1.5 to 2 mm therebetween can be welded, and in that the fluidity of a weld pool can be improved as the arc discharge unit rotates, so that the incidence of welding defects, such as undercutting, can be reduced, thus providing high quality welding.

### DESCRIPTION OF DRAWINGS

The patent or application file contains at least one drawing executed in color. Copies of this patent or patent application publication with color drawings will be provided by the office upon request and payment of the necessary fee.

FIG. 1 is a view showing a laser-rotating arc hybrid welding system according to the present invention;

FIG. 2 is a view schematically showing a welding method using the laser-rotating arc hybrid welding system according to the present invention;

FIG. 3 is a flowchart showing respective steps of the welding method using the laser-rotating arc hybrid welding system according to the present invention;

FIG. 4 is a conceptual view showing the arc rotating direction of the laser-rotating arc hybrid welding system according to the present invention;

FIG. 5 is a graph showing the signal characteristics of welding current according to the present invention;

FIG. 6 is a graph showing the difference between left and right areas caused by offset according to the present invention; and

FIGS. 7 and 8 are views showing the photographs of a welded state obtained by the laser-rotating arc hybrid welding system according to the present invention.

* Description of reference characters of important parts *

| | |
|---|---|
| 2: arc discharge unit | 4: laser emission unit |
| 22: MIG torch | 24: rotating device |
| 26: connection device | 44: laser radiator |

### BEST MODE

Hereinafter, embodiments of the present invention will be described in detail with reference to the attached drawings.

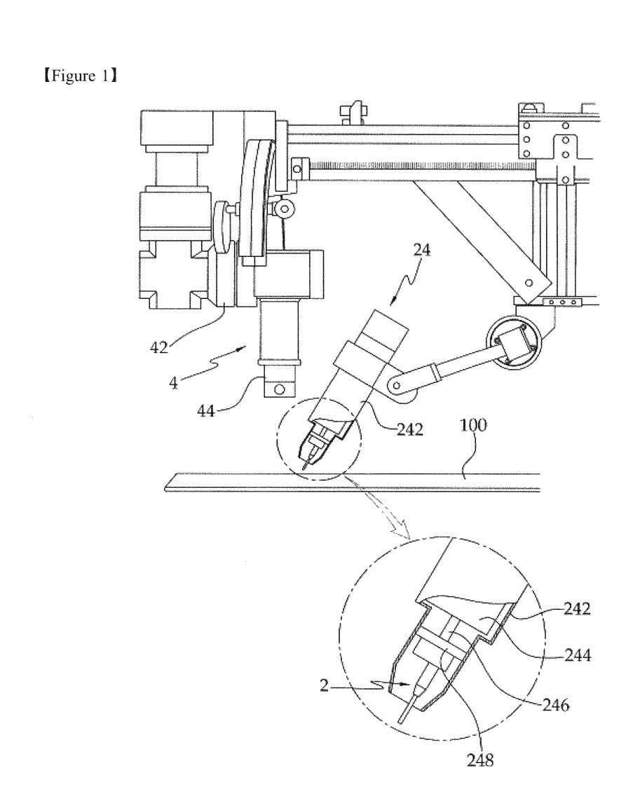

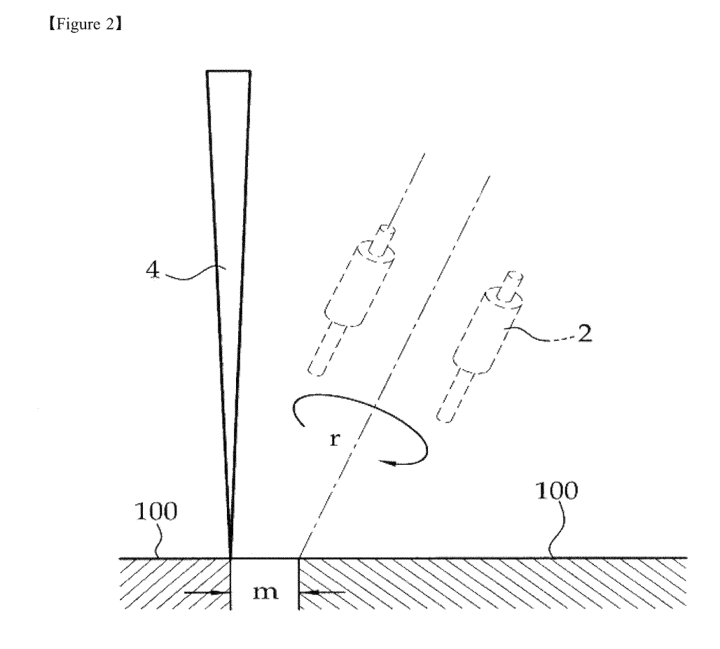

FIG. 1 is a view showing a laser-rotating arc hybrid welding system according to the present invention.

Referring to FIG. 1, the welding system according to the present invention includes an arc discharge unit 2 for generating arc discharge along an area to be welded; a laser generation unit 4 installed behind the arc discharge unit 2 and radiating laser light onto the area to be welded; and a rotating device 24 for rotating the arc discharge unit 2.

The arc discharge unit 2 is installed on the rotating device 24, which will be described later, and is adapted to perform arc welding. In an embodiment of the present invention, an MIG torch is used as the arc discharge unit 2, and is installed in front of a laser radiator 44, which will be described later, that is, forward in a welding direction, while being inclined at a predetermined angle.

Here, ⊚IG ⊚stands for ⊚etal inert gas, which denotes a kind of gas metal arc welding of performing welding using an inert gas, such as argon or helium, and which is adapted to prevent the oxidation and nitrification of molten metal using inert gas and to perform welding while a welding rod (welding wire) is continuously provided.

Meanwhile, since the arc discharge unit 2 generates arc discharge while rotating at a predetermined turning radius of r using the rotating device 24 installed on the arc discharge unit 2, a heat source can be sufficiently supplied to an area to be welded, having a gap of up to 1.5 to 2 mm.

That is, MIG welding is advantageous in that, since a self-fusing wire is used as an electrode, an allowable gap range for an area to be welded is increased. The range of welding can extend by rotating the arc discharge unit 2, and thus the allowable gap range can further extend.

In this case, the rotating device 24 includes a casing 242, a motor 244 installed in the casing 242, and a bearing plate 248 coupled to the shaft 246 of the motor 244. The arc discharge unit 2 is installed eccentric with respect to the center of the bearing plate 248.

Therefore, the arc discharge unit 2 can be eccentrically rotated at a predetermined turning radius of r by the rotation of the motor 244.

The laser generation unit 4 is a unit for performing welding by radiating laser light, and is constructed so that a laser radiator 44 is installed to be perpendicular to a predetermined bracket 42.

Generally, laser welding enables relatively fast welding, and is also known as keyhole mode welding, by which even thick steel plates can be welded in a single pass. Further, laser welding is advantageous in that thermal distortion is low due to local heat input.

The above-described laser generation unit 4 and arc discharge unit 2 are constructed so that they are installed on a movable device, such as a robotic arm (not shown), to be moved together, and so that the distance between the radiation point of the laser generation unit 4 and the central point of the rotation of the rotating device 24 is about 5 mm, and the generation point of the arc discharge unit 2 is formed to precede the radiation point of the laser generation unit 4 in a welding direction.

Therefore, arc discharge is first generated, and laser radiation is later performed, but the interval (5 mm) and the time difference (about 0.1 second) between the arc discharge generation and the laser radiation are actually very fine, and thus it is considered that almost a single weld pool is formed through the arc discharge generation and the laser radiation.

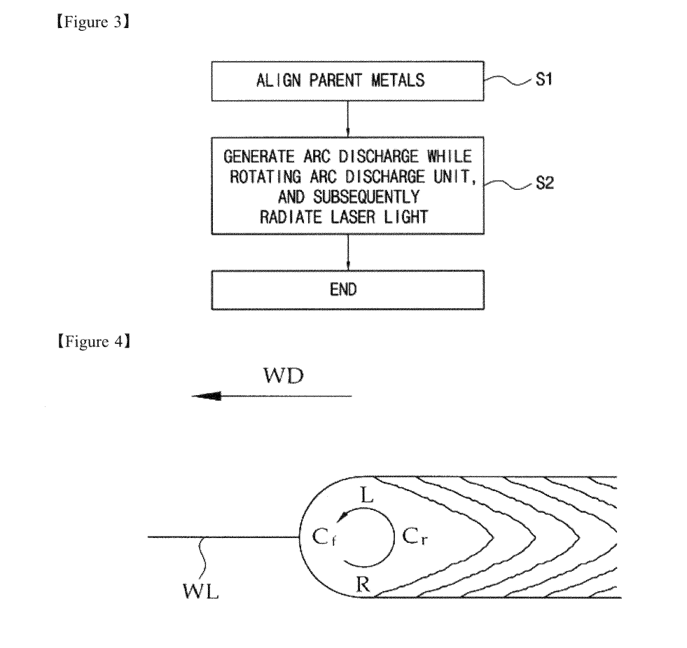

A welding method using the laser-rotating arc hybrid welding system according to the present invention is described with reference to FIG. 3.

FIG. 3 is a flowchart showing respective steps of a laser-rotating arc hybrid welding method according to the present invention.

Referring to FIG. 3, the welding method according to the present invention sequentially performs the first step S1 of aligning a plurality of parent metals 100 with a welding location, and the second step S2 of locating the laser-rotating arc hybrid welding system with respect to an area to be welded, generating arc discharge while rotating the arc discharge unit 2 at a predetermined turning radius, and subsequently radiating laser light using the laser generation unit 4.

At the first step S1, a plurality of parent metals 100 is aligned to have a predetermined gap m therebetween so as to perform butt welding. Here, the gap m between parent metals is preferably set to 2.0 mm or less in consideration of the turning radius r of the arc discharge unit.

Of course, if the turning radius r is increased, the allowable range of the gap between the parent metals is also increased.

Further, in the above description, butt welding is exemplary, but V-groove welding or fillet welding can also be performed, instead of butt welding.

Thereafter, at the second step S2, arc discharge is generated along the area to be welded between the parent metals 100 while the arc discharge unit 4 is rotated, and welding is subsequently performed by radiating laser light using the laser generation unit 4 a short time (about 0.1 second) after the generation of the arc discharge.

Meanwhile, in another embodiment of the welding method according to the present invention, laser radiation may be first performed by the laser generation unit 4, and arc discharge may be subsequently generated by the arc discharge unit 2.

Since the above-described arc discharge generation and laser radiation are performed with a fine time difference (about 0.1 second) therebetween, it can be considered that arc discharge generation and laser radiation are performed almost simultaneously, and these two heat sources form almost a single weld pool.

FIG. 4 is a conceptual view showing the arc rotating direction of the laser-rotating arc hybrid welding system according to the present invention.

Referring to FIG. 4, the welding direction is to the left, and the rotating direction of the arc discharge unit 2 is circulated in the sequence of C_{f}→R →Cᵣ →L.

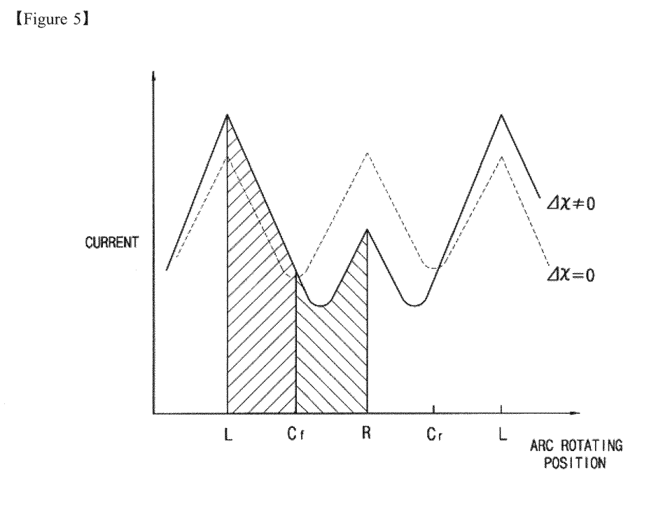

FIG. 5 is a graph showing the signal characteristics of welding current according to the present invention.

Referring to FIG. 5, when a weld line and the center of rotation are identical to each other, the waveform of welding current, indicated as a dotted line, is obtained, whereas, when the weld line and the center of rotation are not identical to each other, the waveform of welding current, indicated as a solid line, is obtained.

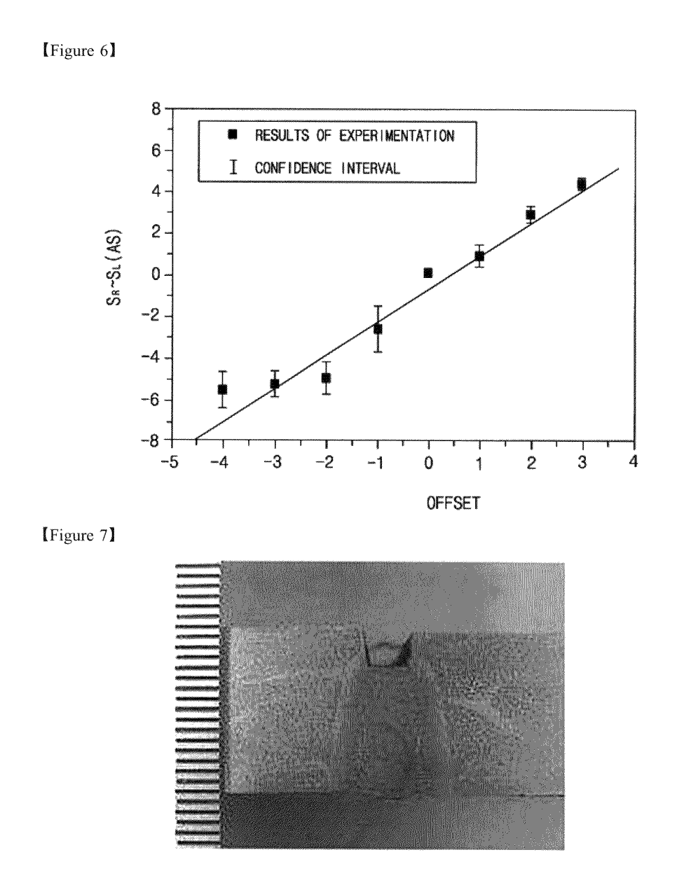

FIG. 6 is a graph showing the difference between left and right areas caused by offset according to the present invention. It can be seen through the results of experimentation that the area to be welded is approximate to a straight line, the confidence interval I is sufficiently small, and thus welding performance is excellent.

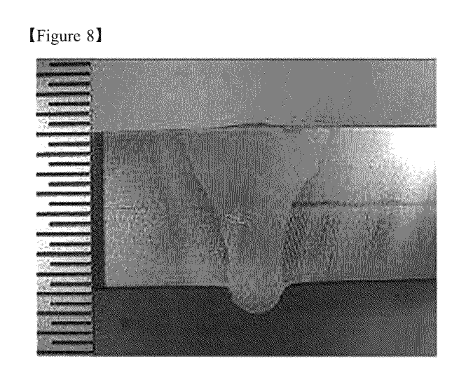

FIGS. 7 and 8 are views showing the photographs of the welded state obtained by the laser-rotating arc hybrid welding system according to the present invention. FIG. 7 illustrates the photograph of parent metal having a gap of 2 mm before a rotating arc is applied, and FIG. 8 illustrates the photograph of the parent metal, the gap of which is welded by applying the rotating arc.

### INDUSTRIAL APPLICABILITY

According to a laser-rotating arc hybrid welding system and a welding method using the welding system, there are advantages in that an arc discharge unit is rotated at a predetermined turning radius to extend the range of welding, so that parts to be butt-welded having a gap ranging from 1.5 to 2 mm therebetween can be welded, and in that, as the arc discharge unit is rotated, the fluidity of the weld pool is improved, so that the incidence of welding defects, such as undercutting, can be reduced, thus providing high quality welding.

1. A laser-rotating arc hybrid welding system, comprising:
an arc discharge unit for generating arc discharge along an area to be welded;
a laser generation unit for radiating laser light onto the area to be welded; and
a rotating device for rotating the arc discharge unit.

2. The laser-rotating arc hybrid welding system according to claim 1, wherein the rotating device comprises a motor installed in a predetermined casing, and a bearing plate coupled to a shaft of the motor, the arc discharge unit being installed eccentric with respect to a center of the bearing plate.

3. The laser-rotating arc hybrid welding system according to claim 2, wherein the arc discharge unit is a Metal Inert Gas (MIG) torch for performing arc welding.

4. The laser-rotating arc hybrid welding system according to claim 2, wherein the laser generation unit is constructed so that a laser radiator is installed on a predetermined bracket to be perpendicular thereto.

5. The laser-rotating arc hybrid welding system according to claim 1, wherein the rotating device is installed such that a center point of a turning radius thereof is formed to precede the laser generation unit in a welding direction.

6. A laser-rotating arc hybrid welding method, comprising:
a first step of aligning a plurality of parent metals with a welding location; and
a second step of locating a laser-rotating arc hybrid welding system with respect to an area to be welded, generating arc discharge while rotating an arc discharge unit at a predetermined turning radius, and subsequently radiating laser light using a laser generation unit.

7. A laser-rotating arc hybrid welding method, comprising:
a first step of aligning a plurality of parent metals with a welding location; and
a second step of locating a laser-rotating arc hybrid welding system with respect to an area to be welded, radiating laser light using a laser generation unit, and subsequently generating arc discharge using an arc discharge unit.

8. The laser-rotating arc hybrid welding system according to claim 2, wherein the rotating device is installed such that a center point of a turning radius thereof is formed to precede the laser generation unit in a welding direction.

9. The laser-rotating arc hybrid welding system according to claim 3, wherein the rotating device is installed such that a center point of a turning radius thereof is formed to precede the laser generation unit in a welding direction.

10. The laser-rotating arc hybrid welding system according to claim 4, wherein the rotating device is installed such that a center point of a turning radius thereof is formed to precede the laser generation unit in a welding direction.
